(19) United States
(12) Patent Application Publication
(10) Pub. No.: US 2005/0229035 A1
(43) Pub. Date: Oct. 13, 2005

(54) Method for event synchronisation, especially for processors of fault-tolerant systems

(76) Inventors: Pavel Peleska, GRAFELFING (DE); Anton Weber, Munchen (DE)

Correspondence Address: Siemens Corporation;Intellectual Property Department, 170 Wood Avenue South, Iselin, NJ, 08830, US

(21) Appl. No.: 10/510,311

(22) PCT Filed: Aug. 7, 2003
(86) PCT No.: PCT/EP03/08794

§ 371 Date: Oct. 1, 2004

(30) Foreign Application Priority Data
Sep. 12, 2002 (EP) 02020602.5
Dec. 12, 2002 (EP) 02027848.7

(51) Int. Cl. G06F 11/00

(52) U.S. Cl. 714/12

(57) ABSTRACT

Redundant systems are often provided with identically mounted processor boards which function according to a lockstep operation. The basic condition for the implementation of a lockstep system is the deterministic behaviour of all of the constituents contained in the board, such as CPUs, chip sets, main memory etc. According to the invention, deterministic behaviour signifies that said constituents supply identical results at identical times, in an error-free case, when the constituents receive identical stimuli at identical times. Deterministic behaviour also presupposes the use of interfaces in clock-controlled synchronism. Asynchronous interfaces cause a certain temporal indeterminacy in the system in many cases, whereby the entire synchronised behaviour of the system cannot be maintained. In order to thus be able to carry out a lockstep operation, the invention relates to a method for the synchronisation of external events which are supplied to a processor (CPU) and influence the same. The external events are intermediately stored accordingly and the processors are presented at identical points in the execution of commands. Problems which are created by the capacity of modern processors to execute commands in parallel are avoided by the fact that the parallel execution of the processors is stopped before the desired point in the command execution is reached and said point is then reached exactly in the single step mode.

### CROSS REFERENCE TO RELATED APPLICATIONS

This application is the US National Stage of International Application No. PCT/EP2003/008794, filed Aug. 7, 2003 and claims the benefit thereof. The International Application claims the benefits of European application No. 02020602.5 filed Sep. 12, 2002 and European application No. 02027848.7 filed Dec. 12, 2002, all of the applications are incorporated by reference herein in their entirety.

### FIELD OF INVENTION

This invention relates to a method, processor and computer system for synchronizing external events for redundant processors.

### BACKGROUND OF INVENTION

In many cases up to several hundred processor boards are used in telecommunication systems, data centers and other highly available systems, to provide the necessary computing power. Such a processor board typically comprises a processor or CPU (Central Processing Unit), a chip set, main memory and peripheral modules.

The probability of a hardware defect occurring per year in a typical processor board is in the single digit percentage range. The large number of processor boards combined in a system means that over the period of one year there is a very high probability of failure of any hardware component, whereby such an individual failure can result in failure of the entire system, if appropriate precautions are not taken.

A high level of system availability is a requirement for telecommunication systems especially and also increasingly for data centers. System availability is expressed as a percentage for example or the maximum permissible downtime per year is specified. Typical requirements are for example an availability of >99.999% or a non-availability of maximum several minutes during the year. As it generally takes a time in the range of several tens of minutes to several hours to replace a processor board and restore the service in the event of a hardware defect, precautions have to be taken for the event of a hardware defect at system level, in order to be able to comply with system availability requirements.

Known solutions for compliance with such stringent system availability requirements provide for redundant system components. The known methods can be divided into two main groups: software-based methods and hardware-based methods.

In the case of software-based methods a form of middleware is typically used. The software-based solution however proves not to be very flexible, as only the (application) software developed for the particular redundancy scheme can be used in such a system. This limits the range of useable (application) software significantly. Also the development of application software for software redundancy principles in practice requires a great deal of time and effort with the development also entailing a complicated test method.

The basic principle of hardware-based methods is based on encapsulating redundancy at hardware level so that it is transparent for the software. The essential advantage of redundancy managed by the hardware itself is that the application software is not impaired by the redundancy principle and therefore in most instances any software can be used.

A principle frequently encountered in practice for hardware-fault-tolerant systems, the redundancy of which is transparent for the software, is what is known as the lockstep principle. Lockstep means that identically structured hardware elements, e.g. two boards, are operated in the same manner with clock-controlled synchronism. Hardware mechanisms ensure that the redundant hardware experiences identical input stimuli at a defined time and therefore has to supply identical results. The results of the redundant components are compared and if there is a difference, a fault is determined and appropriate measures are initiated (operator alarm, partial or total security shutdown, system restart).

The basic condition for the implementation of a lockstep system is the clock-based deterministic behavior of all the components contained in the board, such as CPUs, chip sets, main memory, etc. Clock-based deterministic behavior here means that said components supply identical results at identical clock times, if the components receive identical stimuli at identical clock times. Clock-based deterministic behavior also assumes the use of interfaces in clock-controlled synchronism. Asynchronous interfaces cause a certain temporal indeterminacy in the system in many instances, whereby the entire synchronized behavior of the system cannot be maintained.

However for chip sets and CPUs specifically asynchronous interfaces offer technological advantages with an increase in capacity, as a result of which operation in clock-controlled synchronism according to the lockstep method becomes impossible. Also modern CPUs increasingly use mechanisms, which prevent operation with clock-controlled synchronism. These are for example internal corrective measures, not visible externally, e.g. correction of an internally correctable fault with access to the cache, which can result in a slight delay in command processing or the speculative execution of commands. A further example is the increasing implementation in the future of CPU-internal clock-free execution units, allowing significant advantages with regard to speed and power dissipation but preventing operation of the CPU in clock-controlled synchronism or a deterministic manner.

European patent application 02020602 discloses a method for synchronizing external events, which are supplied to a CPU and influence the same, according to which the external events are stored in an intermediate manner, whereby the stored external events are retrieved in a separate operating mode of the CPU for processing by an execution unit and whereby in this operating mode the CPU enters into compliance with a condition that can be predefined by commands or is predefined in a permanent manner. This method is also referred to as “emulated lockstep operation”.

EP 02020602 advantageously provides for the change to separate operating mode being executed, if a comparator element of the CPU determines the correspondence of a counter to a Maximum Instruction Register (MIR), whereby the content of the MIR can be predefined by commands and the counter contains the number of instructions executed by the execution unit since the last change to separate operating mode.

However modern CPUs cannot be interrupted so that they stop after a precise number of instructions. The reason for this is that a plurality of instructions can be processed in parallel, which are terminated at a common time. Therefore for example in one clock pulse 99 instructions can be processed on all redundant CPUs, in the next clock pulse there are for example 100 instructions on one CPU due to a difference in execution while on another there are 101 instructions. An external event, e.g. an interrupt, can therefore not be presented at identical points in the command execution.

### SUMMARY OF INVENTION

One object of the present invention is to specify a method, with which external events can also be presented at identical points in the command execution of redundant CPUs, even if it is not definitely possible to interrupt the redundant CPUs after execution of one and the same instruction.

This object is achieved by a method for synchronizing external events according to the features of the Claims, by a processor according to the features of the Claims and by a system according to the features of the Claims. Advantageous developments are specified in the dependent Claims.

According to the invention a method is provided for synchronizing external events, which are supplied to a module CPU and influence the same, whereby the module CPU is provided for the parallel processing of a first number of instructions,
according to which the external events are stored in an intermediate manner, whereby the stored external events are retrieved in a separate operating mode of the module for processing by at least one execution unit EU of the module and
whereby the module enters into said operating mode after processing a predefinable second number MIC of instructions, in that
a counter (IC) determines the number of instructions executed by the execution unit since last leaving separate operating mode,
the module is switched to an individual command execution mode, if the counter IC is greater than or equal to the difference between the second number of instructions and a third number MD of instructions, determined from the first number of instructions,
the module remains in individual command execution mode, until the counter IC reaches the second number MIC of instructions, whereupon the module changes to separate operating mode and the counter IC is reinitialized on leaving separate operating mode.

The said third number of instructions is thereby based on the maximum number of instructions executed in parallel and is used to compensate for the indeterminacy described on the interruption of CPUs with the capability to process instructions in a parallel manner. The third number is preferably selected so that it is equal to or greater than the first number of maximum instructions executed in parallel.

In redundant systems comprising at least two modules CPU an identical sequence of instructions is provided for the modules CPU and identical external events are retrieved by the modules in separate operating mode. A faster module CPU is left by a controller in separate operating mode, until a slower module reaches the end of separate operating mode.

The inventive method can be achieved by means of software, microcode or specialized hardware. When the counter IC is monitored by a monitoring software module, the number of executed instructions prompted by the monitoring software module is identified separately and subtracted from the counter IC.

The invention also provides a processor module CPU, which comprises at least the following:
at least one execution unit EU,
at least one counter element IC to count the instructions executed by the execution unit since the last change to a separate operating mode,
at least one register element MIR, the content MIC of which can be predefined by commands or is permanently predefined,
at least one comparator element K and at least one control element S to switch the execution unit EU to an individual command execution mode in response to the counter element IC reaching a predefinable value, which is smaller than the value of the register element MIR, and to switch the execution unit to separate operating mode in response to the correspondence of the counter element IC to the register element MIR, whereby in separate operating mode external events stored in an intermediate manner to be supplied to the processor module CPU, which influence the processor module CPU, are retrieved by the processor module CPU.

A plurality of said processors can be combined advantageously in a system, whereby the system also comprises a connection L0, L1 between at least two of the processor modules CPU, which execute an identical instruction sequence, whereby the connection is provided to transmit synchronization information from separate operating modes.

A significant advantage of the invention is that the use of any new or existing software on a hardware-fault-tolerant platform is allowed, whereby a CPU supporting the invention can be used in said platform without the CPU being required to operate in clock-controlled synchronism and in a deterministic manner and whereby the use of asynchronous high-speed interfaces or links is possible. The invention thereby takes into account the circumstance that modern CPUs with capabilities for parallel processing of instructions cannot be interrupted after a precise number of instructions in every case.

Further advantages are:
The mutually redundant boards and CPUs do not have to be operated with phase-locked linking.
The CPUs do not have to be identical, they only have to stop and change operating mode after the same number of processed machine instructions.
The CPUs can be operated with different clock frequencies.
The CPUs can behave differently in respect of the speculative execution of instructions, as only completed instructions are evaluated.

Different CPU-internal execution times in identical CPUs, e.g. due to corrections after the data-falsifying occurrence of alpha particles, only result in synchronization mode being reached at slightly different times.

### BRIEF DESCRIPTION OF THE DRAWINGS

An exemplary embodiment of the invention is described in more detail below in conjunction with three figures, in which:

FIG. 1 shows a flow diagram of the inventive method,

FIG. 2 shows a diagram of an inventive processor module

FIG. 3 shows a diagram of an inventive system comprising two processor modules according to FIG. 2.

### DETAILED DESCRIPTION OF INVENTION

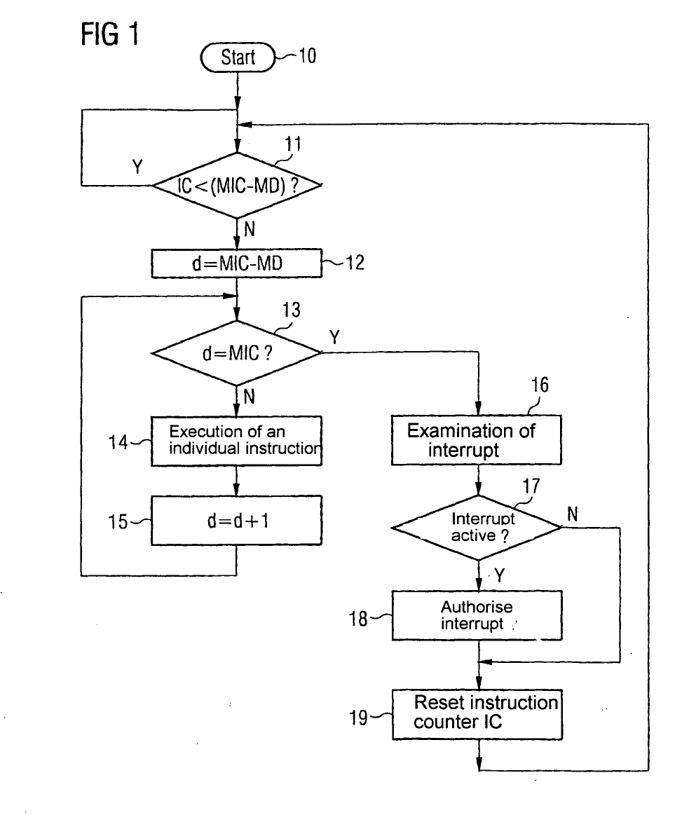

FIG. 1 shows the inventive method graphically in the form of a flow diagram. The following values have to be determined or initialized before the start of the sequence:

A counter IC (Instruction Counter), which contains the number of instructions or machine commands processed by the CPU.

A number MIC (Maximum Instruction Counter) of instructions, after which the CPU should change to special operating mode to process external events.

A number MD (Maximum Deviation) of instructions, which takes into account the maximum indeterminacy of the interruption of the CPU occurring due to the parallel nature of command execution.

The sequence starts with the current value of the command counter IC being compared with the difference between the values MIC and MD (block 11). If the value of the command counter is smaller than this difference, command processing is continued in standard operating mode; parallel execution of instructions is possible. If the value of the command counter reaches or exceeds the difference between MIC and MD, a register d is loaded with the difference between MIC and MD (block 12) and the operation enters a loop, at the start of which it is asked whether the register d has reached the value MIC (block 13). In this loop command processing takes place in single step mode.

As long as the value d does not reach the value MIC, a single instruction is executed in each passage through the loop (block 14) and the value d is incremented (block 15) before the loop condition (block 13) is checked again. This procedure ensures that despite parallel command processing in standard operation the change to separate operating state is effected precisely after MIC instructions.

If the value d reaches the value MIC (block 13), the operation moves into separate operating mode. Separate operating mode first verifies whether an interrupt request has been received during processing of the MIC commands and has been stored in an intermediate manner for simultaneous processing by all redundant CPUs (blocks 16/17). If interrupt requests have been received, these are processed (block 18), whereby said processing is effected by all redundant CPUs at an identical point in program processing and all registers, memory contents, etc. are identical. This stage is omitted, if there are no interrupt requests.

Separate operating mode is terminated and standard operating mode with parallel instruction processing is resumed after the command counter IC has been reset (block 19). An interrupt request can then be processed. The interrupt routine is not processed in separate operating mode but in standard mode. Only the reading in of the interrupt vector is effected in special operating mode, after which special mode is left again. Whether or not the interrupt is processed at this point depends for example on whether interrupts are permitted at this time. Interrupts are not permitted, if an interrupt is just being processed and/or an “interrupt flag” is deleted.

The inventive method can be implemented directly as an instruction sequence, i.e. as software, based on the operation shown. The software thereby ensures that an interrupt is presented at identical points in the command execution of a plurality of processors, by programming an instruction counter in the CPU so that it prompts an exception, e.g. a debug exception, or a high-priority, non-blockable interrupt, e.g. the non-maskable interrupt NMI, after the required number MIC of instructions to be processed minus the “interrupt indeterminacy” MD. For example with an indeterminacy of MD=3 instructions and a required number of MIC=1000 instructions, the counter IC is programmed with 1000−3+1=998. Depending on the internal grouping of instructions, the CPU is therefore stopped after IC=998 or IC=999 or IC=1000 instructions. The software then reads the instruction counter to determine at which point the processor actually stopped. This software is thereby set up so that the execution of its own instructions is corrected accordingly. If the software determines that the CPU has stopped for example after 999 instructions, the required 1000^{th} instruction is executed subsequently by single step operation, controlled by the exception software. This happens with all redundant CPUs, so that all CPUs have then been stopped at the identical point in the code.

Any interruption request present must be presented at this point to the CPU(s). This can be done as follows:

The CPU can read an interrupt controller register, whereupon said interrupt controller releases a masked interrupt signal. The CPU identifies an interrupt request from said interrupt signal and sends an interrupt acknowledge cycle to the interrupt controller. The interrupt controller then supplies the interrupt vector and masks the interrupt signal again.
Alternatively the software can read a register, the value of which provides information about the nature of the interrupt, i.e. the interrupt vector. The software itself then initializes the corresponding interrupt (by software), if interrupts are permitted in command processing at this time.

The operation can also be achieved in the form of microcode instructions. In many instances modern CPUs have a wide number of options for controlling command execution by means of microcode. These options are frequently used for example to eliminate or circumvent design errors.

For the purposes of the inventive method the microcode is modified so that the CPU interrupts standard command execution after the required number of instructions MIC to be processed minus the “interrupt indeterminacy” MD and branches into the microcode. The microcode reads the number of executed instructions IC and initiates execution by single step so that command execution is interrupted at the required point MIC.

Any interrupt request present must in turn be presented to the CPU(s) at this point. This can be done in a number of ways:
An interrupt signal masked by microcode is released by microcode and if there is an interrupt present, the CPU is branched to the corresponding interrupt routine. The interrupt is then masked again by microcode.
Alternatively the CPU can be prompted to generate an interrupt acknowledge cycle and read an interrupt vector. This is then presented to the CPU by microcode so that after leaving separate mode the CPU branches to the corresponding interrupt routine.

Implementation can also be effected in the code conversion software. Some CPUs have a simple but very fast, generally super-scalar RISC or VLIW processor core. The actual command record, e.g. IA-32, is transformed by code conversion software to a simple code and executed by the RISC/VLIW processor. In this case the code conversion software executes the object of the method, in the same way as implementation in microcode. Interrupt requests are presented in the same way as with microcode implementation.

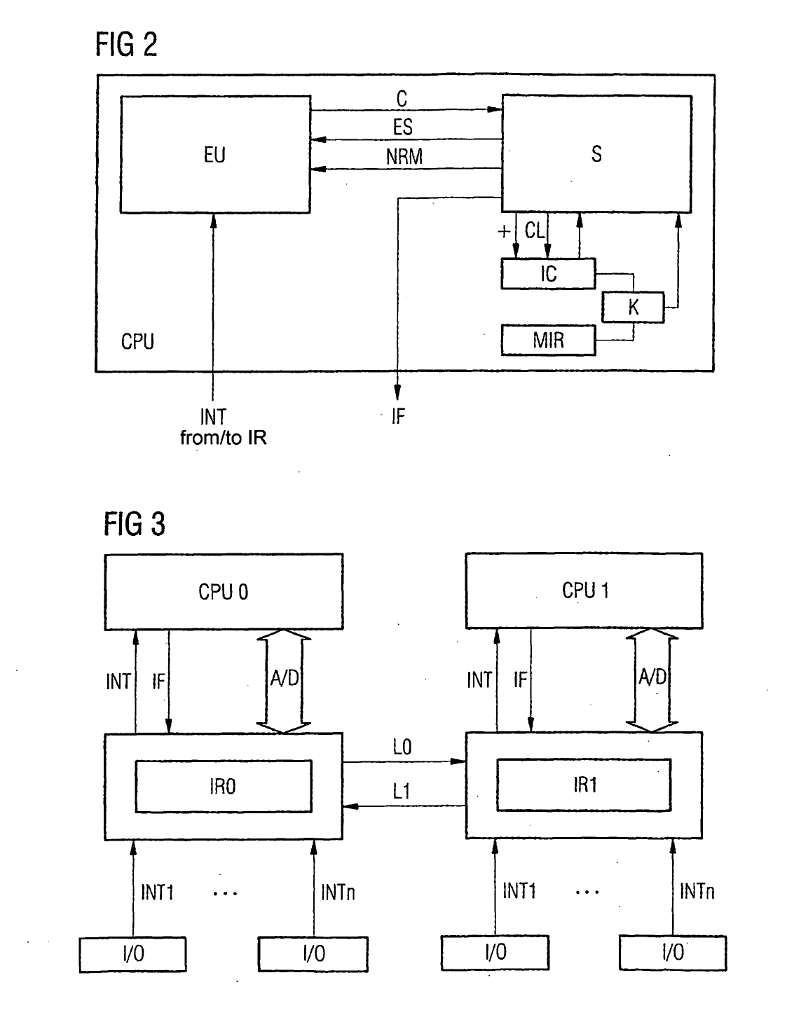

The most efficient implementation of the inventive method is a hardware implementation, as shown in FIG. 2. Here the parallel command execution is interrupted at the required point minus indeterminacy by a processor-internal hardware unit S, the instruction counter status IC is determined and the execution unit EU is moved on by the processor-internal hardware unit S by single step ES to the required point in the code. The essential advantage of this method is the significantly reduced negative influence on performance.

FIG. 2 shows a schematic illustration of an inventive processor module CPU. Only the components of relevance to this invention are shown. The CPU comprises one or a plurality of execution units EU, at least one comparator K, at least one counter IC to count the instructions executed by the execution unit EU, a controller S and at least one register element MIR, the content of which can be predefined by commands or can be permanently predefined. Connections from/to an interrupt register are also shown schematically (FIG. 3).

The external events influencing the program sequence are not supplied directly to the CPU but are first buffered by a suitably configured hardware unit. The method can be implemented in the CPU shown in FIG. 2, by loading the register MIR with the difference between the value MIC and the value MD. The comparator K compares the number of executed operations with this register value and signals the result of said comparison to the control unit S. Alternatively the comparator can also send only one event to the controller, which is generated when the value of the IC has reached the value of the MIR. If this event has occurred or if equality of the two registers has been signaled, the controller S asks the command counter again to read the number of instructions actually executed. As the indeterminacy has already been taken into account in the MIR by loading with the value MIC-MD, the controller can prompt the execution of instructions individually in single step mode, signaled via the line ES to the execution unit, until the value of the command counter reaches the predefined value MIC. For this purpose the controller S is able to increment the command counter IC, unless the command counter counts the instructions executed in single step automatically.

The controller S of every redundant CPU generates an interrupt release signal IF, which is fed to an interrupt module. Notification of an interrupt request, some of which are stored in an intermediate manner, is then given to all redundant CPUs via the interrupt line INT.

Alternatively the controller S generates an interrupt for its own CPU, whereupon the execution units send an interrupt acknowledge cycle to the interrupt module, if interrupts are permitted in the error processing at this time.

In a further alternative an interrupt signal IF is generated by the controller S, which is AND-linked as required to the interrupt signal INT, i.e. the circuit logic should be selected accordingly, if inverted signals are present or if the interrupt signal is presented on a plurality of lines. The interrupt release signal can also be transmitted outside the CPU for example to the interrupt register. Any interrupts present on the interrupt line INT are thereby released and normal interrupt management can take place, e.g. reading of the interrupt vector, execution of the interrupt routine, etc.

Before interrupt management the cancellation of single step mode and separate operating mode and the continuation of command processing in standard mode are signaled to the execution unit and the command counter is reset via a signal CL. The controller can be provided directly as hardware or in the form of microcode.

FIG. 3 finally shows the interconnection of two CPUs according to the above description in conjunction with FIG. 2. Here the first processor CPU0 and the second processor CPU1 are shown without the details from FIG. 2. The processors respectively exchange addresses and data via a bus A/D with assigned interrupt modules, which comprise for example interrupt registers IR0, IR1. The interrupt modules receive interrupts INT1 . . . INTn for example from input/output modules I/O, store corresponding characteristic data and forward the interrupts INT to the processors.

According to the invention the interrupts are only accepted by the processors at specific points in the command execution. This is described in detail in conjunction with FIG. 2.

The interrupt release signal described in this context can also be used to signal to the interrupt module assigned to every processor that interrupt management can be started. The interrupt modules, which are connected via connections L0, L1, can exchange this information and release interrupt management for their part, for example by transmitting the interrupt vector to the processors, if all the processors generate an interrupt release signal.

In one alternative it can prove advantageous not to stop the CPUs at a predefined point MIC in the command execution but at a point affected by the indeterminacy of commands that can be processed in parallel and then to move the processors that are behind on by single step to the point in command processing at which the processor that has progressed furthest in command processing has stopped. This requires communication between the processors. This can be effected for example in such a way that every processor writes the point at which it stopped itself in a hardware register and then reads it back. The register waits until all the processors have written in their value and supplies the highest value as read data. If necessary all the processors then align their command execution status by single step. The interrupt request is then presented to the processors as described above.

CPUs which have SMT (Simultaneous Multi Threading) capabilities have to have a separate controller for every virtual CPU or every thread.

The CPU also comprises the comparator K, which compares the number of executed commands, i.e. the counter IC, with the register MIR and in the event of equality generates an interrupt request for example, which interrupts command execution after the number of instructions predefined by the register MIR and switches the CPU to a different operating mode. In this operating mode for example an appropriate microcode is executed or a branch is made to an interrupt service routine or the reaching of said synchronization point is signaled by hardware signals. In this operating mode the external events are presented to the redundant CPUs in such a way that after leaving said operating mode all the CPUs can evaluate said events in the same way and the same commands are therefore executed as a result.

For example after reaching the number of machine instructions predefined by the register MIR, the CPU branches into an interrupt service routine, in which the status of interrupt signals kept remote from the CPU by the described hardware is requested so that a redundant CPU, which may make said request at a slightly later time, receives identical information.

On leaving separate operating mode the counter IC is reset. There is then a return to the program point, at which the interrupt took place due to reaching the counter value IC predefined by the register MIR. The CPU will then execute the number of machine instructions predefined by the register MIR again and when the counter IC reaches the register value MIR it will change mode, thereby allowing the acceptance of external events.

The CPU registers MIR are advantageously configured so that they can be written by software or microcode, to ensure that interrupt management takes place at appropriate intervals for different areas of use, by determining the time windows for interrupt management according to the number of instructions to be executed.

1.-8. (canceled)

9. A method for synchronizing external events supplied to a CPU in a redundant configuration, comprising:
storing the external events for processing by an execution unit of the CPU;
retrieving the external events for processing by the execution unit of the CPU in a separate operating mode of the CPU;
storing a number of instructions executed by the execution unit since the CPU last leaves the separate operating mode in an instruction counter;
entering the separate operating mode after the number of instructions executed reaches a predefined maximum instruction counter;
switching to an individual command execution mode of the CPU if the number of instructions executed is greater than or equal to the predefined maximum instruction counter and a maximum deviation of instructions; and
remaining in the individual command execution mode until the number of instructions executed reaches the predefined maximum instruction counter, whereupon the CPU switches to the separate operating mode and the number of instructions executed is reinitialized.

10. The method according to claim 9, wherein the maximum deviation of instructions is greater than or equal to a number of instructions executed in parallel.

11. The method according to claim 9, wherein the external events are supplied to a plurality of CPUs.

12. The method according to claim 11, wherein each CPU receives an identical sequence of the instructions.

13. The method according to claim 11, wherein each CPU that is in the separate operating mode retrieves an identical set of the external events.

14. The method according to claim 11, wherein a CPU that is at the end of the separate operating mode remains in the separate operating mode until all redundant CPUs not at the end of the separate operating mode reach the end of the separate operating mode.

15. The method according to claim 9, wherein the number of instructions executed is monitored by a monitoring software CPU, the number of executed instructions prompted by the monitoring software CPU is identified separately and subtracted from the instruction counter.

16. A CPU adapted to operate in a redundant configuration, comprising:
an execution unit;
a counter element that counts a number of instructions executed by the execution unit since the CPU last leaves a separate operating mode of the CPU, the counter element being reinitialized when the CPU leaves the separate operating mode;
a register element containing a value, the value being a maximum instruction count offset by a maximum deviation of instructions when the CPU is in a standard operation mode, and the value being the maximum instruction count when the CPU is in an individual command execution mode;
a comparator element that compares the counter element with the register element; and
a control element that switches the execution unit to the individual command execution mode when the comparator element determines that the counter element matches the register element,
wherein external events are stored for processing by the CPU and the external events are retrieved for processing by the CPU in the separate operating mode.

17. The CPU according to claim 16, wherein the maximum deviation of instructions is greater than or equal to a number of instructions executed in parallel.

18. The CPU according to claim 17, wherein the CPU executes a plurality of instructions in parallel.

19. A computer system adapted to operate in a redundant configuration, comprising:
a plurality of CPUs, each CPU having an execution unit;
a counter element that counts a number of instructions executed by the execution unit since the CPU last leaves a separate operating mode of the CPU, the counter element being reinitialized when the CPU leaves the separate operating mode;
a register element containing a value, the value being a maximum instruction count offset by a maximum deviation of instructions when the CPU is in a standard operation mode, and the value being the maximum instruction count when the CPU is in an individual command execution mode;
a comparator element that compares the counter element with the register element; and
a control element that switches the execution unit to the individual command execution mode when the comparator element determines that the counter element matches the register element,
wherein external events are stored for processing by the CPU and the external events are retrieved for processing by the CPU in the separate operating mode.

20. The system according to claim 19, further comprising a connection between the plurality of CPUs executing an identical instruction sequence, whereby the connection is provided to transmit synchronization.

21. The computer system according to claim 19, wherein the maximum deviation of instructions is greater than or equal to a number of instructions executed in parallel.

22. The computer system according to claim 21, wherein the CPU executes a plurality of instructions in parallel.
